(19) United States
(12) Patent Application Publication
(10) Pub. No.: US 2004/0076285 A1
(43) Pub. Date: Apr. 22, 2004

(54) Telephone interceptor

(76) Inventor: Raj Mahadevaiah, Alpharetta, GA (US)

Correspondence Address: ARNALL GOLDEN GREGORY LLP, Suite 2800, 1201 West Peachtree Street, Atlanta, GA, 30309, US

(21) Appl. No.: 10/685,038

(22) Filed: Oct. 14, 2003

Related U.S. Application Data
(63) Continuation-in-part of application No. 09/648,023, filed on Aug. 25, 2000.
(60) Provisional application No. 60/151,177, filed on Aug. 27, 1999.

(51) Int. Cl. H04M 3/42; H04M 1/00; H04M 3/00

(52) U.S. Cl. 379/373.01; 379/210.02

(57) ABSTRACT

An apparatus (310) for intercepting telephone calls on a telephone channel connected to a telephone includes a ring detector, that is in communication with the telephone channel. The ring detector is capable of detecting an incoming telephone call and generates a ring signal upon detection of an incoming telephone call. A user input receives an input from a user indicating that the user desires not to be called. A counter (320), that is responsive to the user input, is programmed to count a selected amount of time from assertion of the user input. A delay circuit (330), that is responsive to the counter, the ring signal and the user input, is programmed to allow the telephone to ring if an incoming call has been detected and if more than the selected amount of time has passed since the user input was last asserted. The delay circuit (330) is also programmed to prevent the telephone from ringing if an incoming call has been detected and if less than the selected amount of time has passed since the user input was last asserted.

### CROSS REFERENCE TO A PROVISIONAL APPLICATION

This patent application claims priority on Provisional Application Serial No. 60/151,177, filed on Aug. 27, 1999, the entirety of which is hereby incorporated by reference.

### CROSS REFERENCE TO A PREVIOUSLY-FILED U.S. PATENT APPLICATION

This patent application is a continuation-in-part claiming priority on U.S. patent application Ser. No. 09/648,023, filed on Aug. 25, 2000, the entirety of which is hereby incorporated by reference.

### BACKGROUND OF THE INVENTION

1. Field of the Invention

The present invention relates to telephone communications and, more specifically, to a method and apparatus for intercepting and, if necessary, delaying telephone calls.

2. Description of the Prior Art

Existing telephones often ring at inopportune moments, such as a just few minutes after a child has begun a nap, a few minutes after a telephone user has stepped into a bath, or when the user simply desires privacy. Several approaches to this problem are typically employed. For example, one may ignore the telephone and allow an answering machine to answer the telephone. However, this approach may be irritating to the user and may wake the freshly fallen asleep child. The user may also turn the telephone ringer “off.” However, this approach requires that every telephone in a house be turned off also. The user may take the telephone off of the hook. However, this approach causes incoming callers to believe that the user is actively accepting telephone calls, causing considerable frustration. Also, the user may not be able to place outgoing calls with the off-hook approach.

Some telephone sets employ “do not disturb” buttons that inhibit all ringing once activated. However, users often forget to release the do not disturb function once they desire to start receiving calls again and, thus, miss desired incoming calls. Furthermore, such “do not disturb” buttons usually only apply to a single telephone and not an entire household telephone loop.

Therefore, there is a need for a system that allows a user to inhibit ringing of every telephone in a household and, if the user desires, to generate a message indicating that the user wishes not to be called for a selected period of time.

### SUMMARY OF THE INVENTION

The disadvantages of the prior art are overcome by the present invention which, in one aspect, is an apparatus for intercepting telephone calls on a telephone channel connected to a telephone. A ring detector, that is in communication with the telephone channel, is capable of detecting an incoming telephone call and generates a ring signal upon detection of an incoming telephone call. A user input receives an input from a user indicating that the user desires not to be called. A counter, that is responsive to the user input, is programmed to count a selected amount of time from assertion of the user input. A delay circuit, that is responsive to the counter, the ring signal and the user input, is programmed to allow the telephone to ring if an incoming call has been detected and if more than the selected amount of time has passed since the user input was last asserted. The delay circuit is also programmed to prevent the telephone from ringing if an incoming call has been detected and if less than the selected amount of time has passed since the user input was last asserted.

In another aspect, the invention is a method of intercepting telephone calls on a telephone channel connected to a telephone and a user input that indicates that a user desires not to be called. An incoming telephone call is detected on the telephone channel. A ring signal is generated upon detection of an incoming telephone call. It is determined if the user input has been asserted by the user. The telephone is allowed to ring if an incoming call has been detected and if more than a selected amount of time has passed since the user input was last asserted. The telephone is prevented from ringing if an incoming call has been detected and if less than the selected amount of time has passed since the user input was last asserted.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1A is a schematic diagram of one embodiment of the invention.

FIG. 1B is a schematic diagram of a selector circuit employed in one embodiment of the invention.

FIG. 1C is a schematic diagram of a video display circuit employed in one embodiment of the invention.

FIG. 2A is a flow chart showing the timing function.

FIG. 2B is a flow chart showing the inhibiting function.

FIG. 3A is a schematic diagram of one embodiment of an interceptor.

FIG. 3B is a schematic diagram of a timer usable in the embodiment of FIG. 3A.

FIG. 3C is a schematic diagram of a DTMF detector usable in the embodiment of FIG. 3A.

FIG. 3D is a schematic diagram of a power supply driver usable in the embodiment of FIG. 3A.

FIG. 3E is a schematic diagram of voltage regulator usable in the embodiment of FIG. 3A.

FIG. 3F is a schematic diagram of a message generator usable in the embodiment of FIG. 3A.

FIG. 3G is a schematic diagram of a message recording system usable in the embodiment of FIG. 3A.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Also, as used herein, “global computer network” includes the Internet.

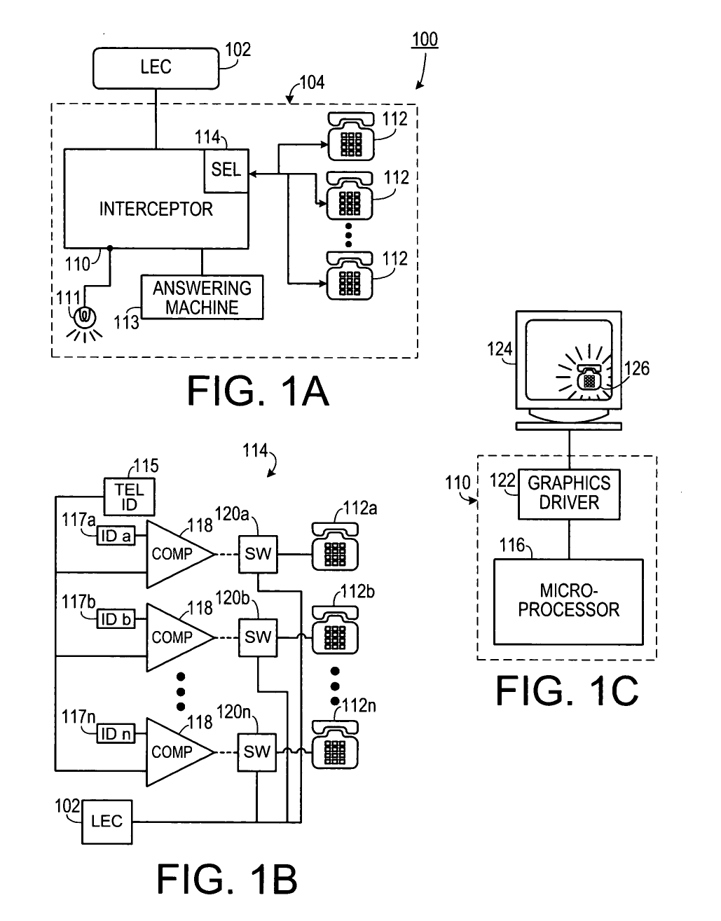

As shown in FIGS. 1A-1C, the present invention 100, includes an interceptor 110 that intercepts telephone calls received from a local exchange carrier (LEC) 102 to a household telephone loop 104. The telephone loop 104 includes one or more telephones 112 connected to a common telephone channel, such as a hard wired telephone line.

The interceptor 110 intercepts incoming telephone calls on the telephone channel and selectively inhibits ringing of the telephone sets 112 connected to the telephone channel for a selected period of time. In one embodiment, a user presses a button, or other user input, that acts like a “snooze bar” on an alarm clock by inhibiting the ringing of the telephone. Once a preselected period from the time the button is depressed has expired, the telephone is allowed to ring normally. A lamp 111 may be used to indicate an incoming call when the ringing is inhibited.

Unlike an answering machine, the invention 100 provides the capability of answering all incoming calls without ringing the telephone sets within a subscriber's local loop for a selected period of time. In one embodiment, each click of the snooze button will provide a progressively longer period of ring delay. For example, one click will delay ringing for 15 minutes, a second click will delay ringing for 30 minutes, a third click will delay ringing for one hour, etc. Even if the invention is currently active, outgoing calls are allowed any time. Unlike a do not disturb button, the inhibitor 110 is capable of inhibiting ringing for only a selected amount of time, after which the user is able to receive telephone calls normally.

The invention may be embodied as a “do not disturb” device, in which the invention detects the ac ring signal on the telephone line and immediately sets the device to an “off-hook” condition. This action completes the circuit to the local telephone exchange (LEC) and DC current flows to the user's local loop. The LEC removes the ringing signal and the ring-back tone from the circuit. This prevents the ringing signal from reaching any of the telephone sets within the user's local loop. In one embodiment, the invention then plays an audio message to the caller with instructions regarding when to call back. The device then returns the line to the on-hook condition.

The device may also generate a call-in-progress indication to the user. This may be done with an indicator light, a text or graphic indication on a video display 124 (e.g., a television or computer screen), or even by playing soft music. The message could even include a caller identification. The user would then have the option to lift the handset and accept the call. In one embodiment, the invention could automatically activate an answering machine 115 during the delay period, allowing the caller to leave a message.

In one illustrative embodiment, a telephone selector circuit 114 is capable of allowing the user to select ringing be inhibited on only certain telephones of a group of commonly-connected telephones. The telephone selector circuit 114 could include an input mechanism for a user to identify the telephones on which to inhibit ringing.

The telephones can communicate with the interceptor so that the telephone keypad could act as an input mechanism. As would be readily appreciated by those of skill in the art, the interceptor 110 can exist as a stand-alone unit, can be embedded into each the telephones 112 (wherein each of several telephones could be in communication with each other—which is already accomplished with telephones already on a common household telephone line) or could reside at the local exchange carrier 102. For example, the telephone keypad could be the input mechanism and the user would indicate an input by pressing a sequence of keys that would not be found in an ordinary telephone number. In one exemplary encoding, the user could input a series of characters to indicate commencement of a programming phase (e.g., “*#”) to indicate that a telephone was being selected. A subsequent entry of a number would identify the telephone (e.g., “03” could indicate telephone number three) and a subsequent character (e.g., “#” could indicate termination of the programming phase. In the case of several telephones being in communication on a single household telephone line, any user inputs entered through the keypad of one telephone is sensed in the form of DTMF tones by all of the other telephones connected to the household telephone line. The telephone identification number would then be stored in a memory location 115 and would be sent to a plurality of comparators 118, each of which compares the number in the memory location 115 to a predetermined number 117a-n that corresponds to a telephone 112a-n. Each comparator 118 controls a switch 120a-n that selectively allows a call from the local exchange carrier 102 to be connected to or blocked from the selected telephone 112a-n.

In one embodiment, the interceptor 110 is controlled by a programmable processor 116 (such as any one of the many N32-type microprocessors that are generally available), that may be coupled to a graphics card 122. The processor 116 would include a memory for holding program instructions and user input. The graphics card 122 may be used to drive a user interface, such as a video display 124. The graphics card 122 could be used, for example, to generated an icon 126 that is indicative of an incoming call during a period when ringing is inhibited.

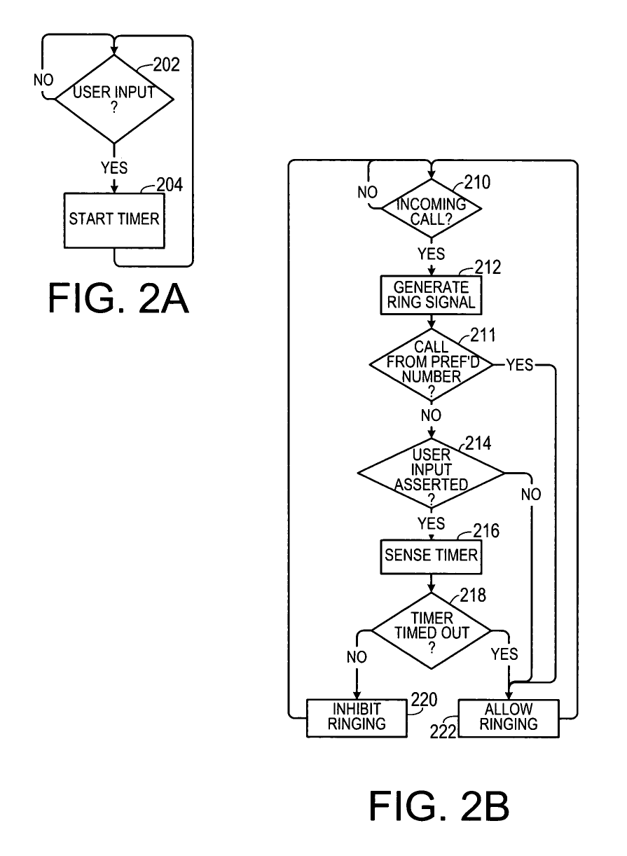

As shown in FIG. 2A, the inhibitor waits until it senses a user input 202 indicating that the user desires not to be called for a selected amount of time. Upon sensing the user input, the inhibitor starts a timer 204. The inhibitor also continuously waits for incoming calls 210. Upon sensing an incoming call, the device asserts a ring signal 212 and determines whether the telephone number of the incoming call corresponds to a list of preferred callers 211. If a preferred caller embodiment is activated, then the user is able to input a list of telephone numbers that the user always wants to cause the telephone to ring. Inputting the list may be accomplished using the keypad of one of the telephones connected to the interceptor by inputting a control sequence. For example, if the user inputs “**##5155551212#” it could cause the telephone number “515-555-1212” to be stored in the user's preferred caller list. This feature could be useful for allowing only calls from family members to cause the telephone to ring, while the rest do not. This list may be input by the user. If the incoming call is from a caller on the list, then the telephone is allowed to ring 222, otherwise the system determines if the user input has been asserted 214. If not, then the telephone is allowed to ring 222, otherwise the inhibitor determines if time remains on the timer 216 (which is typically a count-down timer). If the timer has not timed out then ringing is inhibited 220, otherwise the telephone is allowed to ring 222.

The user input could be a button on a telephone handset, or other device. It could also be entered by pressing a preselected set of keys on a telephone key pad. For example, by entering “*47” (or some other sequence of keys) the user could activate the inhibitor. This could be done by circuitry installed in the local telephone, or could be done by software maintained by the LEC. In fact, all of the functions of the invention could be done either locally or at the LEC.

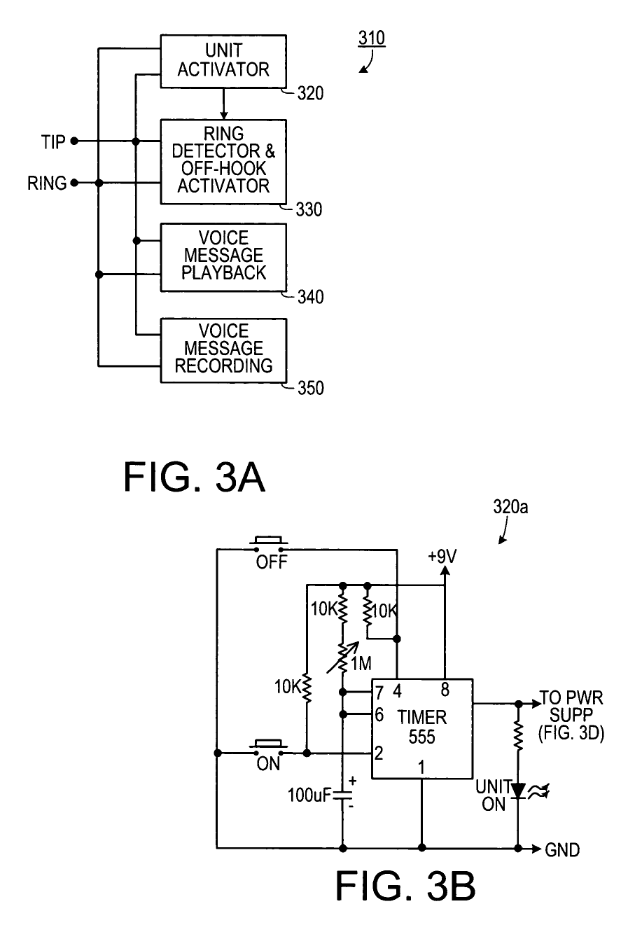

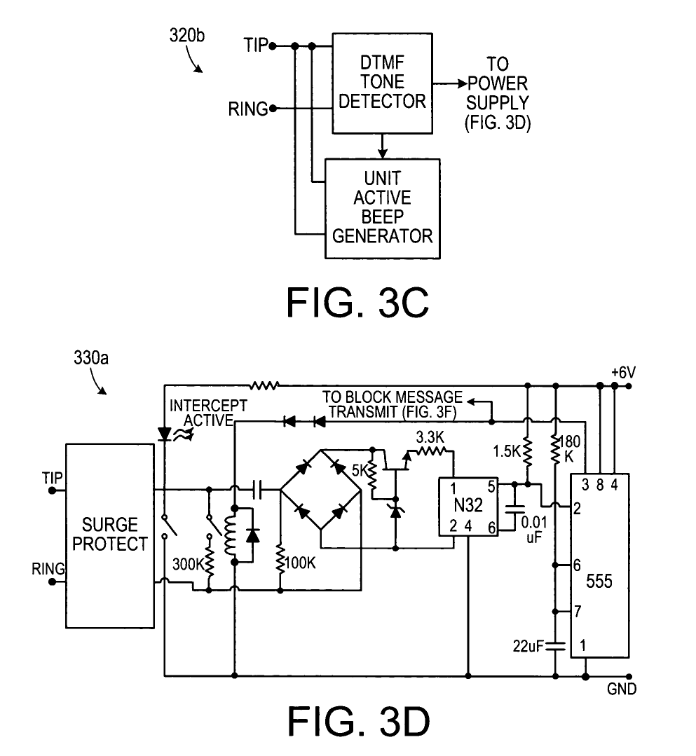

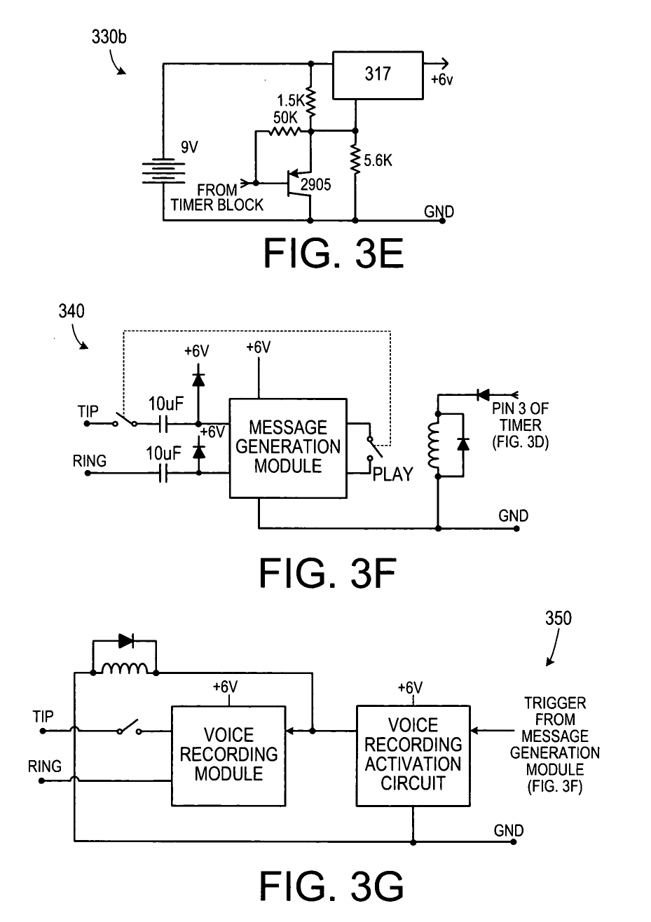

As shown in FIGS. 3A-3G, one embodiment of the invention 310 includes: a unit activator circuit 320 that allows the user to interface with the device, allowing the user to indicate that the user desires not to be called for a selected period; a ring detector and off-hook activator circuit 330 that detects incoming telephone calls and generates a ring signal upon detection of a incoming telephone call, thereby inhibiting ringing of the telephones in a household loop; a voice message playback circuit 340 that generates a voice message to the caller, if the user desires such a message to be generated; and a voice message recording circuit 350 that is used to record voice messages.

The unit activator circuit 320 includes a settable timer circuit, which may be activated by any telephone in the household. The unit activator circuit 320 also includes a circuit 320b that detects DTMF tones on the telephone channel. The ring detector and activator circuit 330 provides a visual indicator that calls are being intercepted and includes a power supply 330a that drives the ring inhibiting function. The power supply 330a allows outgoing calls and allows answering of calls during an interception period. The ring detector and offivator hook activater 330 also includes an off-hook activator 330b.

The voice message playback circuit 340 transmits a user-recorded message indicating that the user is not currently answering telephone calls. The playback circuit 340 could also be programmed to provide an indication to the caller of the amount of time remaining until the caller should try calling again. The voice message recording circuit 350 records messages from callers and acts as an answering machine.

As will be clearly understood by those of skill in the art, the invention could be applied to both hard wired telephone lines, wireless telephone lines and virtual telephone lines (e.g., those formed via the global computer network).

The above described embodiments are given as illustrative examples only. It will be readily appreciated that many deviations may be made from the specific embodiments disclosed in this specification without departing from the invention. Accordingly, the scope of the invention is to be determined by the claims below rather than being limited to the specifically described embodiments above.

What is claimed is:

1. An apparatus for intercepting telephone calls on a telephone channel connected to a telephone, comprising:
a. a ring detector, in communication with the telephone channel, that is capable of detecting an incoming telephone call and that generates a ring signal upon detection of a incoming telephone call;
b. a user input that is capable of receiving an input from a user indicating that the user desires not to be called;
c. a counter, responsive to the user input, programmed to count a selected amount of time from assertion of the user input; and
d. a delay circuit, responsive to the counter, the ring signal and the user input, that is programmed to:
i. allow the telephone to ring if an incoming call has been detected and if more than the selected amount of time has passed since the user input was last asserted; and
ii. prevent the telephone from ringing if an incoming call has been detected and if less than the selected amount of time has passed since the user input was last asserted.

2. The apparatus of claim 1, further comprising a telephone selection circuit, operatively coupled to a plurality of telephones, that includes a user input that indicates to the controller which of the plurality of telephones are to have ringing inhibited.

3. The apparatus of claim 1, further comprising a message playback circuit, responsive to the controller, that plays a message to an incoming caller when the controller inhibits ringing of the telephone.

4. The apparatus of claim 1, further comprising a visual incoming call indicator that provides a visual indication that a telephone call is incoming while the telephone inhibited from ringing.

5. The apparatus of claim 4, wherein the visual incoming call indicator comprises an indicator light.

6. The apparatus of claim 4, wherein the visual incoming call indicator comprises:
a. a video display generator that generates an icon representing an incoming call; and
b. a video display circuit that superimposes the icon onto a video display.

7. The apparatus of claim 6, wherein the video display circuit comprises a text message generator.

8. The apparatus of claim 6, wherein the video display circuit comprises a symbol generator.

9. A method of intercepting telephone calls on a telephone channel connected to a telephone and a user input that indicates that a user desires not to be called, comprising the steps of:
a. detecting an incoming telephone call on the telephone channel;
b. generating a ring signal upon detection of a incoming telephone call;
c. determining if the user input has been asserted by the user; and
d. allowing the telephone to ring if an incoming call has been detected and if more than a selected amount of time has passed since the user input was last asserted; and
e. preventing the telephone from ringing if an incoming call has been detected and if less than the selected amount of time has passed since the user input was last asserted.

10. The method of claim 9, wherein the determining step comprises sensing closing of a switch local to the telephone.

11. The method of claim 9, wherein the determining step comprises sensing of a code entered on a keypad of the telephone.

12. The method of claim 11, further comprising the step of determining a length of a delay during which ringing of the telephone is to be inhibited, the length being based on a selection of keys depressed on a telephone keypad.

13. The method of claim 9, wherein the determining step is completed by a circuit that is integrated into the telephone.

14. The method of claim 9, wherein the determining step is completed by a circuit controlled by a telephone exchange carrier.

15. The method of claim 9, further comprising the steps of:
a. receiving from a user an input of at least one selected caller telephone number;
b. storing the telephone number in a memory;
c. upon receiving an incoming telephone call, comparing an incoming number corresponding to the incoming telephone call to the selected caller telephone number stored in the memory; and
d. if the incoming number matches the selected caller telephone number then executing a first action, otherwise executing a second action different from the first action.

16. The method of claim 15, wherein the first action comprises allowing the telephone to ring and wherein the second action comprises inhibiting the telephone from ringing.

17. The method of claim 15, wherein the first action comprises inhibiting the telephone from ringing and wherein the second action comprises allowing the telephone to ring.
